(19) United States
(12) Patent Application Publication
(10) Pub. No.: US 2022/0197081 A1
(43) Pub. Date: Jun. 23, 2022

(54) POLARIZER AND DISPLAY DEVICE

(71) Applicant: SHENZHEN CHINA STAR OPTOELECTRONICS SEMICONDUCTOR DISPLAY TECHNOLOGY CO., LTD., Shenzhen (CN)

(72) Inventor: Bo HAI, Shenzhen (CN)

(21) Appl. No.: 17/251,279

(22) PCT Filed: Sep. 3, 2020
(86) PCT No.: PCT/CN2020/113182

§ 371 Date: Dec. 11, 2020

(30) Foreign Application Priority Data
Aug. 7, 2020 (CN) 202010792904.8

(51) Int. Cl. G02F 1/1335; G02B 5/30

(52) U.S. Cl. CPC G02F 1/133528; G02B 5/3041; G02F 1/133512

(57) ABSTRACT

The present disclosure provides a polarizer and a display device. Without changing a manufacturing process of a liquid crystal layer, a light-shielding layer is disposed between each film layer of the polarizer or on the edge of each film layer, and the polarizer is disposed on the liquid crystal layer to achieve the bezel-free shading, so that no light leakage occurs in the display device and the display quality of the display device is improved.

### FIELD OF INVENTION

This present disclosure generally relates to the field of display technology, and in particular to a polarizer and a display device.

### BACKGROUND OF INVENTION

Liquid crystal display televisions (LCD TV) have become very popular, and human beings are natural visual animals. Most consumers pay special attention to the appearance when they choose to buy LCD TVs. When “light” and “thin” become the mainstream, bezel-free TVs are undoubtedly more in line with the general public aesthetic. Moreover, in addition to the stylish appearance, the bezel-free TVs can also be regarded as a kind of subversion in terms of viewing effects. As the width of the bezel is reduced, the user can have a wide field of vision when enjoying the TV screen. Even in the same screen size, narrow bezel TVs and bezel-free TVs make people feel much larger sizes and better viewing effects.

However, when the current mass-produced liquid crystal panels are used to manufacture bezel-free display devices, because there is no protection and shielding for the bezel, there are many problems, such as edge light leakage or strabismus light leakage, which affect the display quality of the display device.

### SUMMARY OF INVENTION

The present disclosure provides a polarizer and a display device to solve the light leakage of the display device.

The present disclosure provides a polarizer, comprising:

a first adhesive layer having a first surface and a second surface disposed opposite to each other;

a compensation layer disposed on the first surface;

a second adhesive layer disposed on a surface of the compensation layer away from the first adhesive layer;

a polarizing layer disposed on a surface of the first adhesive layer away from the compensation layer;

a third adhesive layer disposed on a surface of the polarizing layer away from the second adhesive layer;

a protective layer disposed on a surface of the third adhesive layer away from the polarizing layer; and

a light-shielding layer, wherein the light-shielding layer is disposed on an edge of any one of the first adhesive layer, the compensation layer, the second adhesive layer, the polarizing layer, the third adhesive layer, and the protective layer, or the light-shielding layer is disposed on an edge between any two adjacent layers of the first adhesive layer, the compensation layer, the second adhesive layer, the polarizing layer, the third adhesive layer and the protective layer.

In some embodiments, a light-shielding agent is added to the edge of the first adhesive layer to form the light-shielding layer.

In some embodiments, a light-shielding agent is added to the edge of the compensation layer to form the light-shielding layer.

In some embodiments, a light-shielding agent is added to the edge of any one of the second adhesive layer, the third adhesive layer, and the protective layer to form the light-shielding layer.

In some embodiments, a light-shielding agent is added to the edge of the polarizing layer or the protective layer to form the light-shielding layer.

In some embodiments, the light-shielding agent is any of carbon, titanium, and nickel.

In some embodiments, the light-shielding agent is chromium or acrylic resin when the light-shielding layer is disposed on the edge between any two adjacent layers of the first adhesive layer, the compensation layer, the second adhesive layer, the polarizing layer, the third adhesive layer, and the protective layer.

In some embodiments, the first adhesive layer is a pressure-sensitive film layer, and the second adhesive layer and the third adhesive layer are optical film layers.

In some embodiments, the polarizer is quadrilateral, and the light-shielding layer is disposed on at least one edge of the polarizer.

In some embodiments, the first adhesive layer is a pressure-sensitive film layer.

The present disclosure also provides a display device, comprising a liquid crystal layer and a polarizer, and wherein the polarizer is disposed on the liquid crystal layer, and the polarizer comprises:

a first adhesive layer having a first surface and a second surface disposed opposite to each other;

a compensation layer disposed on the first surface;

a second adhesive layer disposed on a surface of the compensation layer away from the first adhesive layer;

a polarizing layer disposed on a surface of the first adhesive layer away from the compensation layer;

a third adhesive layer disposed on a surface of the polarizing layer away from the second adhesive layer;

a protective layer disposed on a surface of the third adhesive layer away from the polarizing layer; and

a light-shielding layer, wherein the light-shielding layer is disposed on an edge of any one of the first adhesive layer, the compensation layer, the second adhesive layer, the polarizing layer, the third adhesive layer, and the protective layer, or the light-shielding layer is disposed on an edge between any two adjacent layers of the first adhesive layer, the compensation layer, the second adhesive layer, the polarizing layer, the third adhesive layer and the protective layer.

In some embodiments, a light-shielding agent is added to the edge of the first adhesive layer to form the light-shielding layer.

In some embodiments, a light-shielding agent is added to the edge of the compensation layer to form the light-shielding layer.

In some embodiments, a light-shielding agent is added to the edge of any one of the second adhesive layer, the third adhesive layer, and the protective layer to form the light-shielding layer.

In some embodiments, a light-shielding agent is added to the edge of the polarizing layer or the protective layer to form the light-shielding layer.

In some embodiments, the light-shielding agent is any of carbon, titanium, and nickel.

In some embodiments, the light-shielding agent is chromium or acrylic resin when the light-shielding layer is disposed on the edge between any two adjacent layers of the first adhesive layer, the compensation layer, the second adhesive layer, the polarizing layer, the third adhesive layer, and the protective layer.

In some embodiments, the first adhesive layer is a pressure-sensitive film layer, and the second adhesive layer and the third adhesive layer are optical film layers.

In some embodiments, the polarizer is quadrilateral, and the light-shielding layer is disposed on at least one edge of the polarizer.

In some embodiments, the first adhesive layer is a pressure-sensitive film layer.

### Advantageous Effects

The embodiment of the present disclosure provides a polarizer and a display device. The polarizer comprises a first adhesive layer, a compensation layer, a second adhesive layer, a polarizing layer, a third adhesive layer, a protective layer, and a light-shielding layer. The first adhesive layer has a first surface and a second surface disposed opposite to each other, and the compensation layer is disposed on the first surface. The second adhesive layer is disposed on a surface of the compensation layer away from the first adhesive layer. The polarizing layer is disposed on a surface of the first adhesive layer away from the compensation layer. The third adhesive layer is disposed on a surface of the polarizing layer away from the second adhesive layer. The protective layer is disposed on a surface of the third adhesive layer away from the polarizing layer; and the light-shielding layer is disposed on an edge of any one of the first adhesive layer, the compensation layer, the second adhesive layer, the polarizing layer, the third adhesive layer, and the protective layer, or the light-shielding layer is disposed on an edge between any two adjacent layers of the first adhesive layer, the compensation layer, the second adhesive layer, the polarizing layer, the third adhesive layer and the protective layer. In this disclosure, without changing a manufacturing process of the liquid crystal layer, the light-shielding layer is disposed between each film layer of the polarizer or on the edge of each film layer, and the polarizer is disposed on the liquid crystal layer to achieve the bezel-free shading, so that no light leakage occurs in the display device, and the display quality of the display device is improved.

### DESCRIPTION OF DRAWINGS

In order to make the descriptions of the technique solutions of the embodiments of the present disclosure or the existed techniques, the drawings necessary for describing the embodiments or the existed techniques are briefly introduced below. Obviously, the drawings described below are only some embodiments of the present disclosure, and, for those with ordinary skill in this field, other drawings can be obtained from the drawings described below without creative efforts.

FIG. 1 is a schematic diagram showing the first type of a polarizer provided in the embodiment of the present disclosure.

FIG. 2 is a schematic diagram showing the second type of a polarizer provided in the embodiment of the present disclosure.

FIG. 3 is a schematic diagram showing the third type of a polarizer provided in the embodiment of the present disclosure.

FIG. 4 is a schematic diagram showing the fourth type of a polarizer provided in the embodiment of the present disclosure.

FIG. 5 is a schematic diagram showing the fifth type of a polarizer provided in the embodiment of the present disclosure.

FIG. 6 is a schematic diagram showing the sixth type of a polarizer provided in the embodiment of the present disclosure.

FIG. 7 is a schematic diagram showing the seventh type of a polarizer provided in the embodiment of the present disclosure.

FIG. 8 is a schematic diagram showing the eighth type of a polarizer provided in the embodiment of the present disclosure.

FIG. 9 is a schematic diagram showing the ninth type of a polarizer provided in the embodiment of the present disclosure.

FIG. 10 is a schematic diagram showing the tenth type of a polarizer provided in the embodiment of the present disclosure.

FIG. 11 is a schematic diagram showing the eleventh type of a polarizer provided in the embodiment of the present disclosure.

FIG. 12 is a planar diagram showing the first type of a polarizer provided in the embodiment of the present disclosure.

FIG. 13 is a planar diagram showing the second type of a polarizer provided in the embodiment of the present disclosure.

FIG. 14 is a planar diagram showing the third type of a polarizer provided in the embodiment of the present disclosure.

FIG. 15 is a planar diagram showing the fourth type of a polarizer provided in the embodiment of the present disclosure.

FIG. 16 is a schematic diagram showing a display device provided in the embodiment of the present disclosure.

### DETAILED DESCRIPTION OF PREFERRED EMBODIMENTS

The technical solutions in the embodiments of the present disclosure will be described clearly and completely hereinafter with reference to the accompanying drawings in the embodiments of the present disclosure. Apparently, the described embodiments are merely some but not all embodiments of the present disclosure. All other embodiments obtained by persons with ordinary skill in the art based on the embodiments of the present invention without creative efforts shall fall within the protection scope of the present invention.

It is noted that, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto.

The embodiment of the present disclosure provides a polarizer and a display device, and the following is a introduction to the detail of the polarizer.

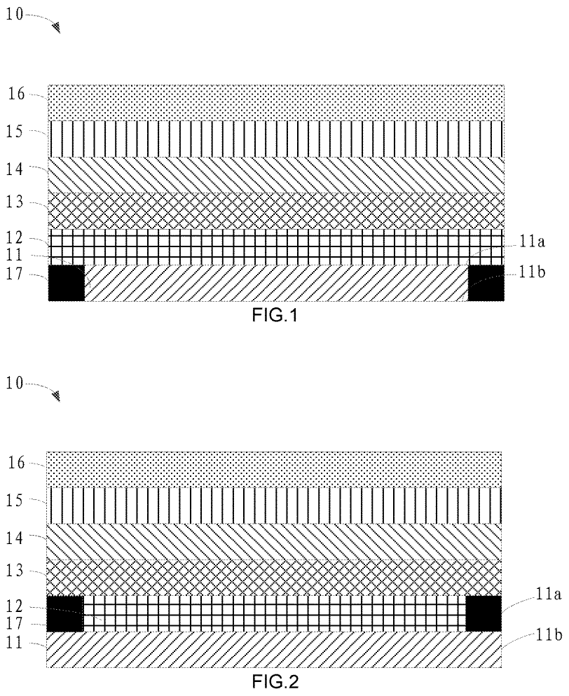

Please refer to FIG. 1-FIG. 11, the polarizer 10 comprises a first adhesive layer 11, a compensation layer 12, a second adhesive layer 13, a polarizing layer 14, a third adhesive layer 15, a protective layer 16, and a light-shielding layer 17. The first adhesive layer 11 has a first surface and a second surface disposed opposite to each other, and the compensation layer 12 is disposed on the first surface. The second adhesive layer 13 is disposed on a surface of the compensation layer away from the first adhesive layer 11. The polarizing layer 14 is disposed on a surface of the first adhesive layer 11 away from the compensation layer 12. The third adhesive layer 15 is disposed on a surface of the polarizing layer 14 away from the second adhesive layer 13. The protective layer 16 is disposed on a surface of the third adhesive layer 15 away from the polarizing layer 14. The light-shielding layer 17 is disposed on an edge of any one of the first adhesive layer 11, the compensation layer 12, the second adhesive layer 13, the polarizing layer 14, the third adhesive layer 15, and the protective layer 16, or the light-shielding layer 17 is disposed on an edge between any two adjacent layers of the first adhesive layer 11, the compensation layer 12, the second adhesive layer 13, the polarizing layer 14, the third adhesive layer 15 and the protective layer 16.

Thus, the first surface is the upper surface of the first adhesive layer 11, and the second surface is the lower surface of the second adhesive layer 13. Certainly, in some embodiments, the positions of the first surface and the second surface can be exchanged.

In addition, the first adhesive layer 11 is a pressure-sensitive film layer. The compensation layer 12 can be used in various forms of display devices 100, wherein the compensation layer 12 has compensation value in a VA display device, and the compensation layer 12 has no compensation value in IPS display device. The second adhesive layer 13 and the third adhesive layer 15 are optical film layers. The polarizing layer 14 is a polyvinyl alcohol layer.

In addition, the light-shielding layer 17 is disposed on an edge of any one of the first adhesive layer 11, the compensation layer 12, the second adhesive layer 13, the polarizing layer 14, the third adhesive layer 15, and the protective layer 16, or the light-shielding layer 17 is disposed on an edge between any two adjacent layers of the first adhesive layer 11, the compensation layer 12, the second adhesive layer 13, the polarizing layer 14, the third adhesive layer 15 and the protective layer 16. In other words, the light-shielding layer 17 may be disposed on the same layer as any one of the first adhesive layer 11, the compensation layer 12, the second adhesive layer 13, the polarizing layer 14, the third adhesive layer 15, and the protective layer 16. Certainly, the light-shielding layer 17 can also be disposed between any two adjacent layers of the first adhesive layer 11, the compensation layer 12, the second adhesive layer 13, the polarizing layer 14, the third adhesive layer 15, and the protective layer 16.

Please refer to FIG. 1. FIG. 1 is a schematic diagram showing the first type of a polarizer provided in the embodiment of the present disclosure, wherein a light-shielding agent is added to the edge of the first adhesive layer 11 to form the light-shielding layer 17.

It is understandable that the light-shielding agent is mixed into the edge of the first adhesive layer 11 to form a black light-shielding layer 17 on the edge of the first adhesive layer 11, so that the edge of polarizer 10 has a shielding effect.

Please refer to FIG. 2. FIG. 2 is a schematic diagram showing the second type of a polarizer provided in the embodiment of the present disclosure, wherein a light-shielding agent is added to the edge of the compensation layer 12 to form the light-shielding layer 17.

It is understandable that the light-shielding agent is mixed into the edge of the compensation layer 12 to form a black light-shielding layer 17 on the edge of the compensation layer 12, so that the edge of polarizer 10 has a shielding effect.

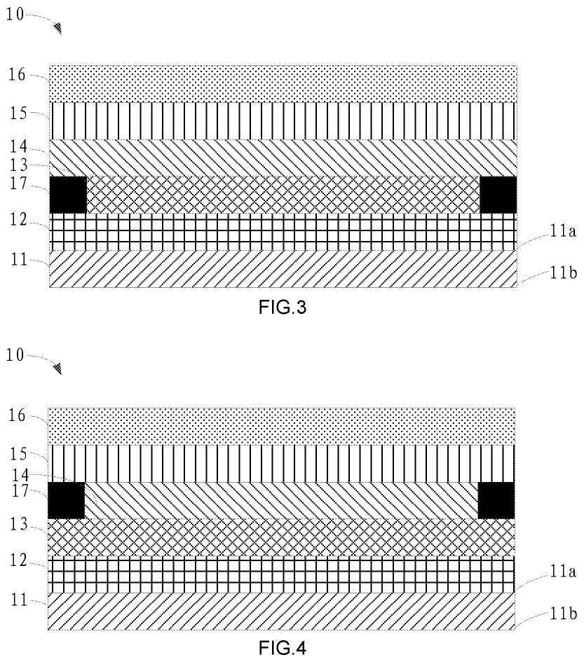

Please refer to FIG. 3. FIG. 3 is a schematic diagram showing the third type of a polarizer provided in the embodiment of the present disclosure, wherein a light-shielding agent is added to the edge of the second adhesive layer 13 to form the light-shielding layer 17.

It is understandable that the light-shielding agent is mixed into the edge of the second adhesive layer 13 to form a black light-shielding layer 17 on the edge of the second adhesive layer 13, so that the edge of polarizer 10 has a shielding effect.

Please refer to FIG. 4. FIG. 4 is a schematic diagram showing the fourth type of a polarizer provided in the embodiment of the present disclosure, wherein a light-shielding agent is added to the edge of the polarizing layer 14 to form the light-shielding layer 17.

It is understandable that the light-shielding agent is mixed into the edge of the polarizing layer 14 to form a black light-shielding layer 17 on the edge of the polarizing layer 14, so that the edge of polarizer 10 has a shielding effect.

Please refer to FIG. 5. FIG. 5 is a schematic diagram showing the fifth type of a polarizer provided in the embodiment of the present disclosure, wherein a light-shielding agent is added to the edge of the third adhesive layer 15 to form the light-shielding layer 17.

It is understandable that the light-shielding agent is mixed into the edge of the third adhesive layer 15 to form a black light-shielding layer 17 on the edge of the third adhesive layer 15, so that the edge of polarizer 10 has a shielding effect.

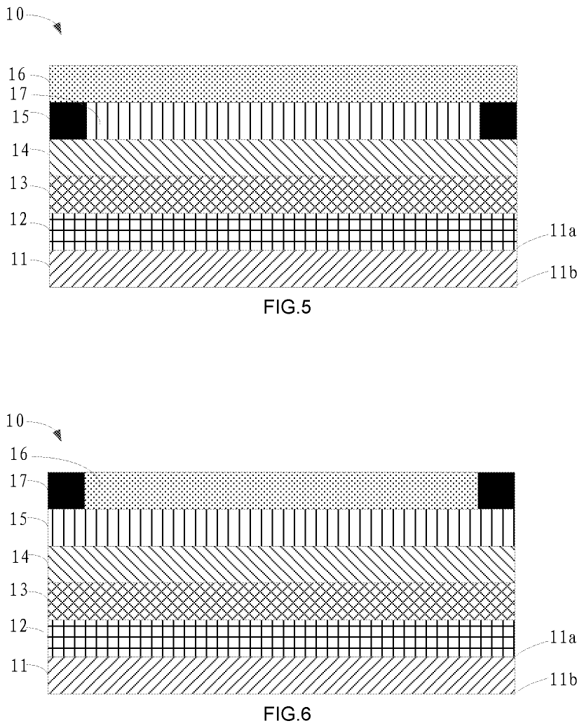

Please refer to FIG. 6. FIG. 6 is a schematic diagram showing the sixth type of a polarizer provided in the embodiment of the present disclosure, wherein a light-shielding agent is added to the edge of the protective layer 16 to form the light-shielding layer 17.

It is understandable that the light-shielding agent is mixed into the edge of the protective layer 16 to form a black light-shielding layer 17 on the edge of the protective layer 16, so that the edge of polarizer 10 has a shielding effect.

In some embodiments, the light-shielding agent is any of carbon, titanium, and nickel. The light-shielding agent may also be somethings else. The light-shielding agent can form black resin with materials in any of the first adhesive layer 11, the compensation layer 12, the second adhesive layer 13, the polarizing layer 14, the third adhesive layer 15, and the protective layer 16, and then form the light-shielding layer 17.

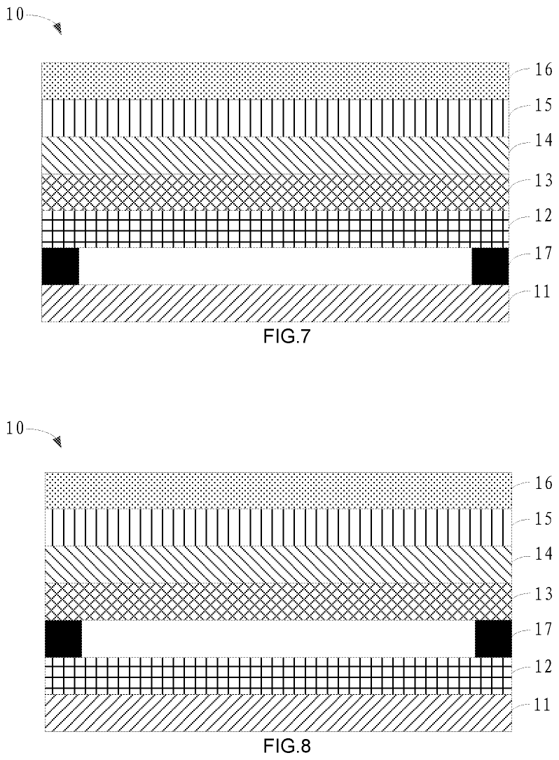

Please refer to FIG. 7, FIG. 7 is a schematic diagram showing the seventh type of a polarizer provided in the embodiment of the present disclosure, wherein the light-shielding layer 17 is disposed on the edge between the first adhesive layer 11 and the compensation layer 12.

It is understandable that by disposing the light-shielding layer 17 on the edge between the first adhesive layer 11 and the compensation layer 12, the edge of polarizer 10 has a shielding effect so as to avoid light leakage of the display device 100 and improve the display quality of the display device 100.

Please refer to FIG. 8, FIG. 8 is a schematic diagram showing the eighth type of a polarizer provided in the embodiment of the present disclosure, wherein the light-shielding layer 17 is disposed on the edge between the second adhesive layer 13 and the compensation layer 12.

It is understandable that by disposing the light-shielding layer 17 on the edge between the second adhesive layer 13 and the compensation layer 12, the edge of polarizer 10 has a shielding effect so as to avoid light leakage of the display device 100 and improve the display quality of the display device 100.

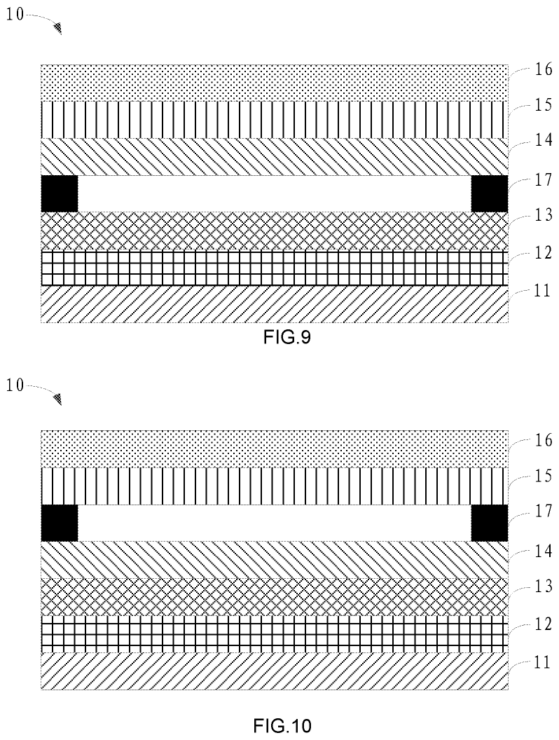

Please refer to FIG. 9, FIG. 9 is a schematic diagram showing the ninth type of a polarizer provided in the embodiment of the present disclosure, wherein the light-shielding layer 17 is disposed on the edge between the second adhesive layer 13 and the polarizing layer 14.

It is understandable that by disposing the light-shielding layer 17 on the edge between the second adhesive layer 13 and the polarizing layer 14, the edge of polarizer 10 has a shielding effect so as to avoid light leakage of the display device 100 and improve the display quality of the display device 100.

Please refer to FIG. 10, FIG. 10 is a schematic diagram showing the tenth type of a polarizer provided in the embodiment of the present disclosure, wherein the light-shielding layer 17 is disposed on the edge between the third adhesive layer 15 and the polarizing layer 14.

It is understandable that by disposing the light-shielding layer 17 on the edge between the third adhesive layer 15 and the polarizing layer 14, the edge of polarizer 10 has a shielding effect so as to avoid light leakage of the display device 100 and improve the display quality of the display device 100.

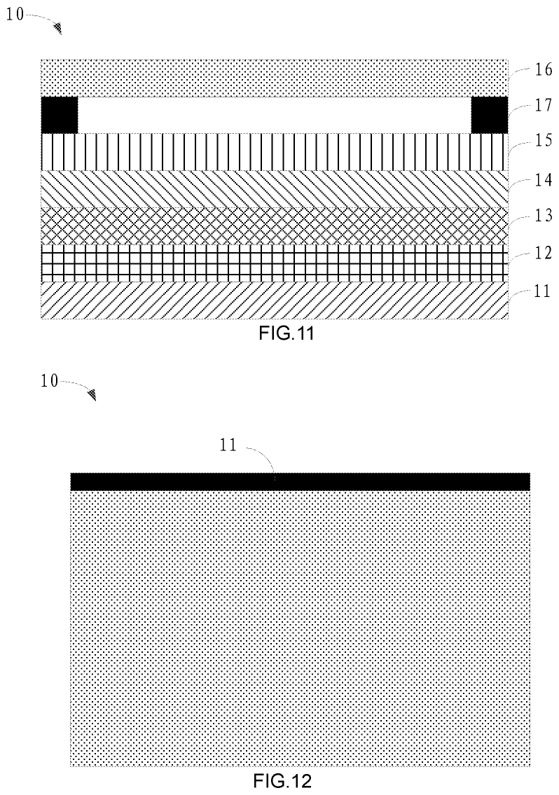

Please refer to FIG. 11, FIG. 11 is a schematic diagram showing the eleventh type of a polarizer provided in the embodiment of the present disclosure, wherein the light-shielding layer 17 is disposed on the edge between the third adhesive layer 15 and the protective layer 16.

It is understandable that by disposing the light-shielding layer 17 on the edge between the third adhesive layer 15 and the protective layer 16, the edge of polarizer 10 has a shielding effect so as to avoid light leakage of the display device 100 and improve the display quality of the display device 100.

In some embodiments, a material of the light-shielding layer 17 is chromium or acrylic resin when the light-shielding layer 17 is disposed on the edge between any two adjacent layers of the first adhesive layer 11, the compensation layer 12, the second adhesive layer 13, the polarizing layer 14, the third adhesive layer 15, and the protective layer 16. Chromium or acrylic resin

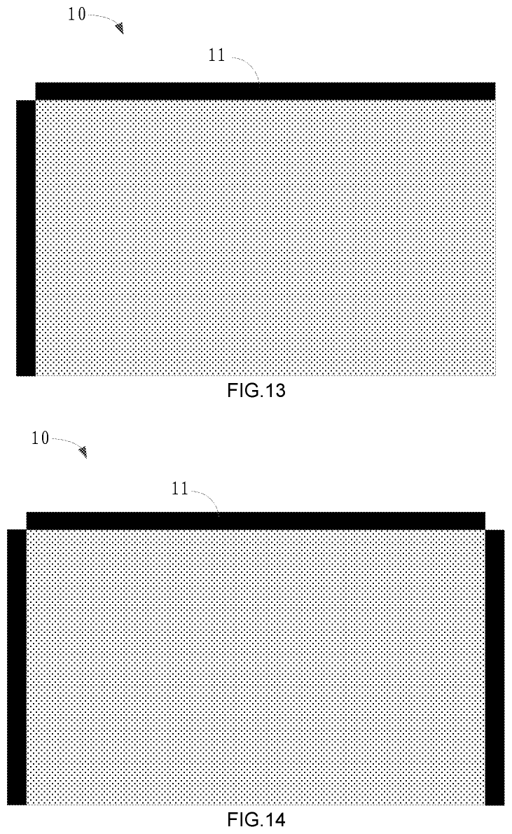

Please refer to FIG. 12-FIG. 15, in some embodiments, the polarizer 10 is any one of quadrilateral, circular and polygon. Specifically, when the polarizer 10 is quadrilateral, the light-shielding layer 17 is disposed on at least one edge of the polarizer 10. For example, the light-shielding layer 17 is disposed on one edge of the polarizer 10, or the light-shielding layer 17 is disposed on two edges of the polarizer 10, or the light-shielding layer 17 is disposed on three edges of the polarizer 10, or the light-shielding layer 17 is disposed on four edges of the polarizer 10.

The embodiment of the present disclosure provides a polarizer and a display device. The polarizer 10 comprises a first adhesive layer 11, a compensation layer 12, a second adhesive layer 13, a polarizing layer 14, a third adhesive layer 15, a protective layer 16, and a light-shielding layer 17. The first adhesive layer 11 has a first surface and a second surface disposed opposite to each other, and the compensation layer 12 is disposed on the first surface. The second adhesive layer 13 is disposed on a surface of the compensation layer away from the first adhesive layer 11. The polarizing layer 14 is disposed on a surface of the first adhesive layer 11 away from the compensation layer 12. The third adhesive layer 15 is disposed on a surface of the polarizing layer 14 away from the second adhesive layer 13. The protective layer 16 is disposed on a surface of the third adhesive layer 15 away from the polarizing layer 14; and the light-shielding layer 17 is disposed on an edge of any one of the first adhesive layer 11, the compensation layer 12, the second adhesive layer 13, the polarizing layer 14, the third adhesive layer 15, and the protective layer 16, or the light-shielding layer 17 is disposed on an edge between any two adjacent layers of the first adhesive layer 11, the compensation layer 12, the second adhesive layer 13, the polarizing layer 14, the third adhesive layer 15 and the protective layer 16. In this disclosure, without changing a manufacturing process of the liquid crystal layer 20, the light-shielding layer 17 is disposed between each film layer of the polarizer 10 or on the edge of each film layer, and the polarizer 10 is disposed on the top of the liquid crystal layer 20 to achieve the bezel-free shading, so that no light leakage occurs in the display device 100 and the display quality of the display device 100 is improved.

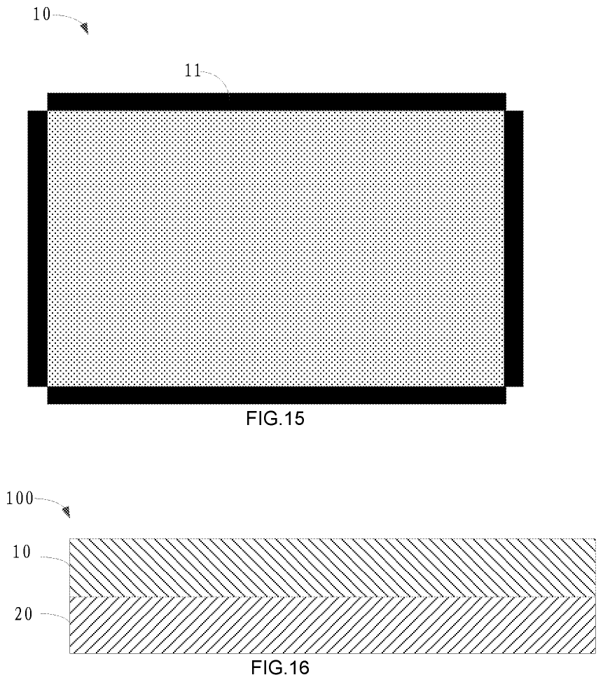

Please refer to FIG. 16, FIG. 16 is a schematic diagram showing a display device provided in the embodiment of the present disclosure. The display device 100 comprises a liquid crystal layer 20 and a polarizer 10, wherein the polarizer 10 which is the described above is disposed on the top of the liquid crystal layer 20. The polarizer 10 has been described in the above embodiments. Therefore, the details of the polarizer 10 will not be repeated here.

The foregoing contents are detailed description of the disclosure in conjunction with specific preferred embodiments and concrete embodiments of the disclosure are not limited to these descriptions. For the person skilled in the art of the disclosure, without departing from the concept of the disclosure, simple deductions or substitutions can be made and should not be construed as limiting of the present disclosure.

1. A polarizer, comprising
a first adhesive layer having a first surface and a second surface disposed opposite to each other;
a compensation layer disposed on the first surface;
a second adhesive layer disposed on a surface of the compensation layer away from the first adhesive layer;
a polarizing layer disposed on a surface of the second adhesive layer away from the compensation layer;
a third adhesive layer disposed on a surface of the polarizing layer away from the second adhesive layer;
a protective layer disposed on a surface of the third adhesive layer away from the polarizing layer; and
a light-shielding layer, wherein the light-shielding layer is disposed on an edge of any one of the first adhesive layer, the compensation layer, the second adhesive layer, the polarizing layer, the third adhesive layer, and the protective layer, or the light-shielding layer is disposed on an edge between any two adjacent layers of the first adhesive layer, the compensation layer, the second adhesive layer, the polarizing layer, the third adhesive layer and the protective layer.

2. The polarizer as claimed in claim 1, wherein a light-shielding agent is added to the edge of the first adhesive layer to form the light-shielding layer.

3. The polarizer as claimed in claim 1, wherein a light-shielding agent is added to the edge of the compensation layer to form the light-shielding layer.

4. The polarizer as claimed in claim 1, wherein a light-shielding agent is added to the edge of any one of the second adhesive layer, the third adhesive layer, and the protective layer to form the light-shielding layer.

5. The polarizer as claimed in claim 1, wherein a light-shielding agent is added to the edge of the polarizing layer or the protective layer to form the light-shielding layer.

6. The polarizer as claimed in claim 2, wherein the light-shielding agent is any of carbon, titanium, and nickel.

7. The polarizer as claimed in claim 1, wherein the light-shielding agent is chromium or acrylic resin when the light-shielding layer is disposed on the edge between any two adjacent layers of the first adhesive layer, the compensation layer, the second adhesive layer, the polarizing layer, the third adhesive layer, and the protective layer.

8. The polarizer as claimed in claim 1, wherein the first adhesive layer is a pressure-sensitive film layer, and the second adhesive layer and the third adhesive layer are optical film layers.

9. The polarizer as claimed in claim 1, wherein the polarizer is quadrilateral, and the light-shielding layer is disposed on at least one edge of the polarizer.

10. The polarizer as claimed in claim 1, wherein the first adhesive layer is a pressure-sensitive film layer.

11. A display device, comprising a liquid crystal layer and a polarizer, and wherein the polarizer is disposed on the liquid crystal layer, and the polarizer comprises:
a first adhesive layer having a first surface and a second surface disposed opposite to each other;
a compensation layer disposed on the first surface;
a second adhesive layer disposed on a surface of the compensation layer away from the first adhesive layer;
a polarizing layer disposed on a surface of the second adhesive layer away from the compensation layer;
a third adhesive layer disposed on a surface of the polarizing layer away from the second adhesive layer;
a protective layer disposed on a surface of the third adhesive layer away from the polarizing layer; and
a light-shielding layer, wherein the light-shielding layer is disposed on an edge of any one of the first adhesive layer, the compensation layer, the second adhesive layer, the polarizing layer, the third adhesive layer, and the protective layer, or the light-shielding layer is disposed on an edge between any two adjacent layers of the first adhesive layer, the compensation layer, the second adhesive layer, the polarizing layer, the third adhesive layer and the protective layer.

12. The display device as claimed in claim 11, wherein a light-shielding agent is added to the edge of the first adhesive layer to form the light-shielding layer.

13. The display device as claimed in claim 11, wherein a light-shielding agent is added to the edge of the compensation layer to form the light-shielding layer.

14. The display device as claimed in claim 11, wherein a light-shielding agent is added to the edge of any one of the second adhesive layer, the third adhesive layer, and the protective layer to form the light-shielding layer.

15. The display device as claimed in claim 11, wherein a light-shielding agent is added to the edge of the polarizing layer or the protective layer to form the light-shielding layer.

16. The display device as claimed in claim 12, wherein the light-shielding agent is any of carbon, titanium, and nickel.

17. The display device as claimed in claim 11, wherein the light-shielding agent is chromium or acrylic resin when the light-shielding layer is disposed on the edge between any two adjacent layers of the first adhesive layer, the compensation layer, the second adhesive layer, the polarizing layer, the third adhesive layer and the protective layer.

18. The display device as claimed in claim 11, wherein the first adhesive layer is a pressure-sensitive film layer, and the second adhesive layer and the third adhesive layer are optical film layers.

19. The display device as claimed in claim 11, wherein the polarizer is quadrilateral, and the light-shielding layer is disposed on at least one edge of the polarizer.

20. The display device as claimed in claim 11, wherein the first adhesive layer is a pressure-sensitive film layer.
